(19) United States
(12) Patent Application Publication
(10) Pub. No.: US 2019/0359000 A1
(43) Pub. Date: Nov. 28, 2019

(54) Pneumatic Tire

(71) Applicant: The Yokohama Rubber Co., LTD., Tokyo (JP)

(72) Inventor: Masanori Ishikawa, Hiratsuka-shi, Kanagawa (JP)

(21) Appl. No.: 16/317,807

(22) PCT Filed: Apr. 3, 2017
(86) PCT No.: PCT/JP2017/013995

§ 371 Date: Jan. 14, 2019

(30) Foreign Application Priority Data
Jul. 15, 2016 (JP) 2016-140682

(51) Int. Cl. B60C 3/04; B60C 9/20

(52) U.S. Cl. CPC B60C 3/04; B60C 2009/2012; B60C 9/20

(57) ABSTRACT

A pneumatic tire includes a carcass layer and a belt layer disposed outward of the carcass layer in the tire radial direction, and also includes, in a tread surface thereof, a plurality of circumferential main grooves and a plurality of land portions defined by the circumferential main grooves. In addition, when the tire is mounted on a specified rim, is inflated to 5% of a specified internal pressure, and is in an unloaded state, upon defining points P1, P2, and P3 on a carcass profile, a distance Da in the tire radial direction from an intersection point P1 to a point P2 and a distance Db in the tire radial direction from the point P2 to a point P3 have a relationship of Db≤Da.

### TECHNICAL FIELD

The technology relates to a pneumatic tire, and particularly relates to a pneumatic tire capable of improving a groove cracking resistance performance.

### BACKGROUND ART

For heavy duty radial tires mounted on trucks, buses, and the like, there is a demand for suppressing the generation of a crack in a groove bottom of an outermost circumferential main groove. As conventional pneumatic tires that satisfy this demand, a technology described in Japan Unexamined Patent Publication No. H11-180109 is known.

### SUMMARY

The technology provides a pneumatic tire capable of improving a groove cracking resistance performance.

A pneumatic tire includes a carcass layer and a belt layer disposed outward of the carcass layer in a tire radial direction, and also includes, in a tread surface thereof, a plurality of circumferential main grooves and a plurality of land portions defined by the plurality of circumferential main grooves. The circumferential main grooves disposed outermost in a tire lateral direction are defined as outermost circumferential main grooves, and the land portions defined by the outermost circumferential main grooves and disposed outward in the tire lateral direction are defined as shoulder land portions. When viewed in a cross-section in the tire meridian direction, an intersection point P1 is defined between a carcass profile and a straight line that passes through a point Pe of an edge portion of the shoulder land portion on the outermost circumferential main groove side and that is parallel with a tire equatorial plane. A point P2 is defined on the carcass profile in a position corresponding to 95% of a distance Dtw from the tire equatorial plane to a tire ground contact edge in the tire lateral direction, and a distance D2 is defined from the point P2 to a maximum width position of the carcass profile in the tire lateral direction. A point P3 is defined on the carcass profile in a position corresponding to 50% of a distance D2 from the point P2. When the tire is mounted on a specified rim, is inflated to an air pressure corresponding to 5% of a specified internal pressure, and is in an unloaded state, a distance Da from the intersection point P1 to the point P2 in the tire radial direction and a distance Db from the point P2 to the point P3 in the tire radial direction have a relationship of Db≤Da.

In the pneumatic tire according to the technology, the shape of a carcass profile in a tread portion shoulder region is made appropriate, and the maximum distortion of a groove bottom of an outermost circumferential main groove after inflation is reduced. Accordingly, the generation of a groove crack in the outermost circumferential main groove is suppressed, and this is advantageous for improving groove cracking resistance performance of the tire.

### BRIEF DESCRIPTION OF DRAWINGS

FIG. 1 is a cross-sectional view in a tire meridian direction illustrating a pneumatic tire according to an embodiment of the technology.

FIG. 2 is an enlarged view illustrating a shoulder portion of the pneumatic tire illustrated in FIG. 1.

FIG. 3 is an explanatory diagram illustrating a belt layer of the pneumatic tire illustrated in FIG. 1.

FIG. 4 is an explanatory diagram illustrating an effect of the pneumatic tire illustrated in FIG. 2.

FIG. 5 is an explanatory diagram illustrating an effect of the pneumatic tire illustrated in FIG. 2.

FIG. 6 is an explanatory diagram illustrating an effect of a pneumatic tire in the related art.

FIG. 7 is a table showing the results of performance tests of pneumatic tires according to the embodiment of the technology.

### DETAILED DESCRIPTION

An embodiment of the technology is described below in detail with reference to the drawings. However, the technology is not limited to the embodiment. Moreover, constituents of the embodiment include elements that are substitutable while maintaining consistency with the technology, and include obviously substitutable elements. Furthermore, a plurality of modified examples described in the embodiment can be combined discretionary within the scope obviousness to one skilled in the art.

### Pneumatic Tire

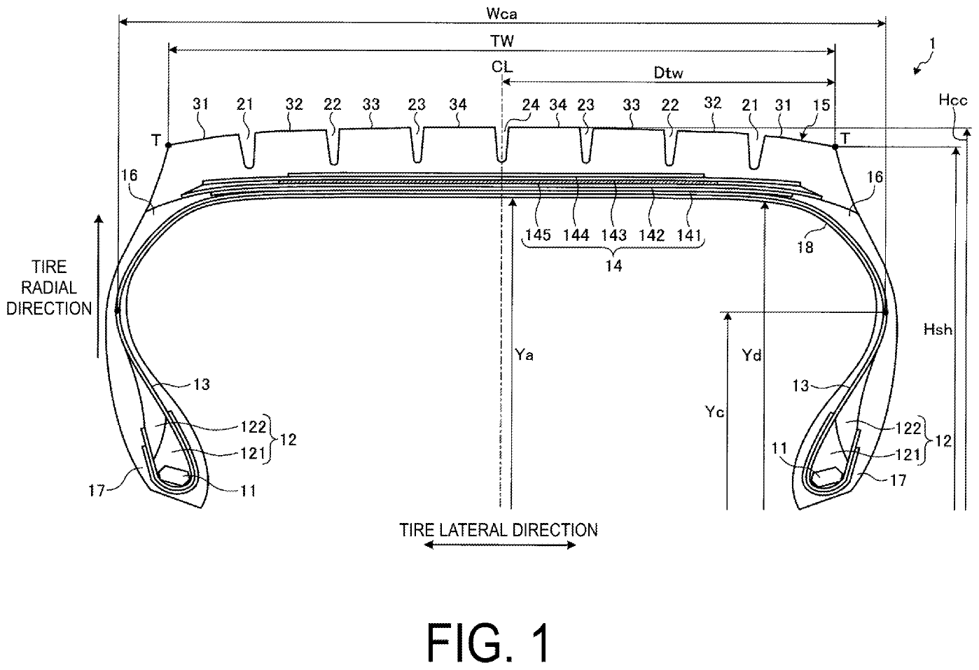

FIG. 1 is a cross-sectional view in a tire meridian direction illustrating a pneumatic tire according to an embodiment of the technology. The drawing is a cross-sectional view illustrating a half region in a tire radial direction. In addition, as an example of a pneumatic tire, the same drawing illustrates a heavy duty radial tire that is mounted on trucks, buses, and the like for long-distance transport. Note that in the same drawing, a circumferential reinforcing layer 145, which is described below, is indicated by hatching.

In reference to the same drawing, the “cross section in a tire meridian direction” refers to a cross section of the tire taken along a plane that includes the tire rotation axis (not illustrated). A reference sign CL denotes the tire equatorial plane and refers to a plane that is perpendicular to the tire rotation axis and passes through the center point of the tire in the tire rotation axis direction. A “tire lateral direction” refers to the direction parallel with the tire rotation axis, and a “tire radial direction” refers to the direction perpendicular to the tire rotation axis.

A pneumatic tire 1 has an annular structure centered around the tire rotation axis, and includes a pair of bead cores 11, 11, a pair of bead fillers 12, 12, a carcass layer 13, a belt layer 14, a tread rubber 15, a pair of sidewall rubbers 16, 16, a pair of rim cushion rubbers 17, 17, and an inner liner 18 (see FIG. 1).

The pair of bead cores 11, 11 are annular members configured by a plurality of bead wires bundled together. The pair of bead cores 11, 11 configure cores of left and right bead portions. The pair of bead fillers 12, 12 are each formed from a lower filler 121 and an upper filler 122. The pair of bead fillers 12, 12 are disposed outward of the pair of bead cores 11, 11 in the tire radial direction and configure the bead portions.

The carcass layer 13 extends between the left and right bead cores 11, 11 in a toroidal form, and configures the framework of the tire. In addition, both end portions of the carcass layer 13 are turned back from the inside in the tire lateral direction to the outside in the tire lateral direction so as to wrap around the bead cores 11 and the bead fillers 12, and fixed. Also, the carcass layer 13 is configured by performing a rolling process of rubber-cover coating on a plurality of carcass cords made of steel or an organic fiber material (nylon, polyester, rayon, or the like, for example), and has a carcass angle (inclination angle in the longitudinal direction of the carcass cords with respect to the tire circumferential direction), as an absolute value, ranging from 85 degrees to 95 degrees.

The belt layer 14 has a multilayer structure formed by a plurality of belt plies 141 to 145 and is disposed being wound over the outer circumference of the carcass layer 13. A specific configuration of the belt layer 14 is described below.

The tread rubber 15 is disposed outward of the carcass layer 13 and the belt layer 14 in the tire radial direction and configures a tread portion of the tire. The pair of sidewall rubbers 16, 16 are disposed outward of the carcass layer 13 in the tire lateral direction and configure left and right sidewall portions. The pair of rim cushion rubbers 17, 17 are disposed inward of the left and right bead cores 11, 11 and turned back portions of the carcass layer 13 in the tire radial direction, and configure contact surfaces of the left and right bead portions to contact rim flanges.

The inner liner 18 is an air permeation preventing layer that is disposed on a tire cavity surface and covers the carcass layer 13. The inner liner 18 is configured by a band-like rubber sheet, for example. This inner liner 18 suppresses oxidation caused by exposure of the carcass layer 13, and also prevents leakage of air filled in the tire.

### Main Grooves and Land Portions

In addition, the pneumatic tire 1 includes, in a tread surface, a plurality of circumferential main grooves 21 to 24 extending in the tire circumferential direction and a plurality of land portions 31 to 34 defined by the circumferential main grooves 21 to 24 (see FIG. 1).

The main groove is a groove for which display of the wear indicator specified by JATMA (Japan Automobile Tyre Manufacturers Association, Inc.) is obligatory, and in a heavy duty radial tire, the main groove generally has a groove width of 4.0 mm or more and a groove depth ranging from 6.5 mm to 25.5 mm.

The groove width is the maximum value of the distance between left and right groove walls at a groove opening portion, and measured in a state where the tire is mounted on a specified rim, is inflated to a specified internal pressure, and is in an unloaded state. In a configuration in which the land portions include notch portions or chamfered portions on edge portions thereof, the groove width is measured with reference to intersection points where the tread contact surface and extension lines of the groove walls meet, when viewed in a cross-section that is normal to the groove length direction. In addition, in a configuration in which the grooves extend in a zigzag-like or wave-like manner in the tire circumferential direction, the groove width is measured with reference to the center line of the amplitude of the groove walls.

The groove depth is the maximum value of the distance from the tread contact surface to the groove bottom, and measured in a state where the tire is mounted on a specified rim, is inflated to a specified internal pressure, and is in an unloaded state. In addition, in a configuration in which the grooves partially include ridged/grooved portions or sipes on the groove bottom, the groove depth is measured excluding these portions.

“Specified rim” refers to an “applicable rim” specified by the Japan Automobile Tyre Manufacturers Association Inc. (JATMA), a “Design Rim” specified by the Tire and Rim Association, Inc. (TRA), or a “Measuring Rim” specified by the European Tyre and Rim Technical Organisation (ETRTO). In addition, “specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. In addition, “specified load” refers to a “maximum load capacity” specified by JATMA, the maximum value in “TIRE LOAD LIMITS AT VARIOUS COLD INFLATION PRESSURES” specified by TRA, or a “LOAD CAPACITY” specified by ETRTO. However, in the case of JATMA, for a passenger vehicle tire, the specified internal pressure is air pressure of 180 kPa, and the specified load is 88% of the maximum load capacity.

In one region having the tire equatorial plane CL as a boundary, the left and right circumferential main grooves 21, 21 located outermost in the tire lateral direction are defined as outermost circumferential main grooves. In general, a distance (dimension symbols are omitted in the drawings) from the tire equatorial plane CL to the groove center line of the outermost circumferential main groove ranges from 38% to 43% of a tire ground contact width TW.

The “tire ground contact width TW” is a maximum linear distance in the tire axial direction of a contact surface between the tire and a flat plate, measured when the tire is mounted on a specified rim, inflated to a specified internal pressure, placed perpendicularly to the flat plate in a static state, and loaded with a load corresponding to the specified load.

A “tire ground contact edge T” is defined as a maximum width position in the tire axial direction of the contact surface between the tire and a flat plate, when the tire is mounted on a specified rim, inflated to a specified internal pressure, placed perpendicularly to the flat plate in a static state, and loaded with a load corresponding to the specified load.

In addition, of the plurality of land portions 31 to 34 defined by the circumferential main grooves 21 to 24, the outermost land portions 31 in the tire lateral direction are defined as shoulder land portions. The shoulder land portions 31 are outer land portions in the tire lateral direction defined by the outermost circumferential main grooves 21, and include tire ground contact edges T on the road contact surface thereof. In addition, the land portions 32 located in the second row from the outside in the tire lateral direction are defined as second land portions. The second land portions 32 are inner land portions in the tire lateral direction defined by the outermost circumferential main grooves 21, and disposed adjacent to the shoulder land portions 31 while sandwiching the outermost circumferential main grooves 21 therebetween.

### Belt Layer

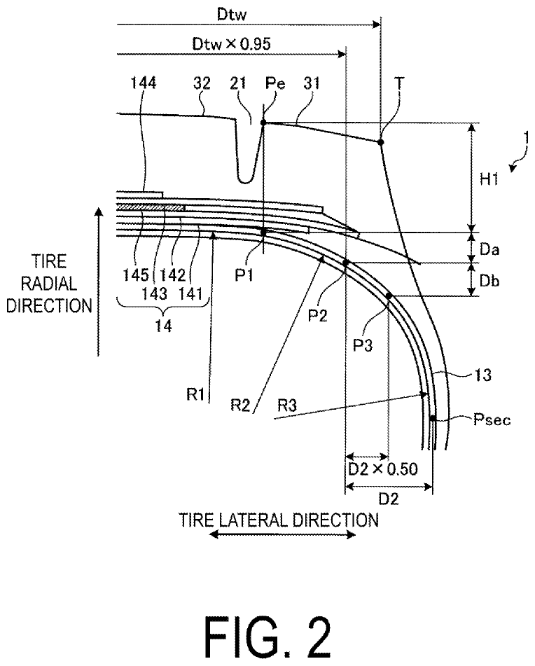

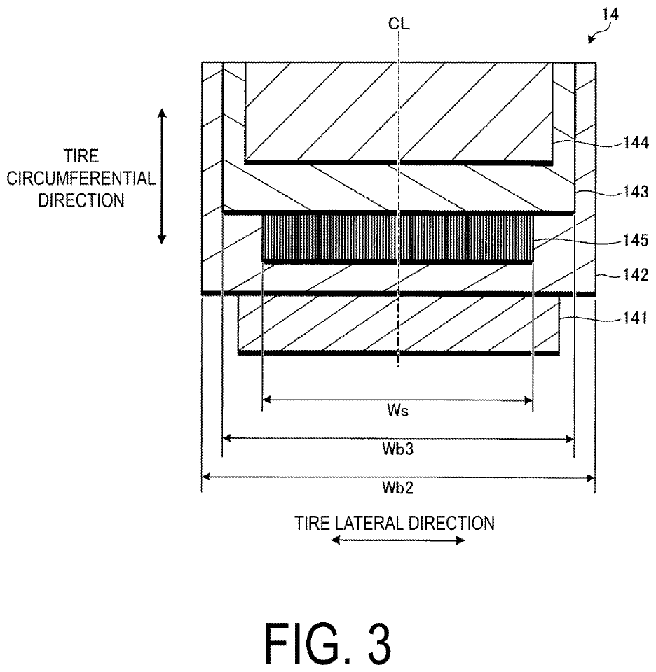

FIG. 2 is an enlarged view illustrating a shoulder portion of the pneumatic tire illustrated in FIG. 1. FIG. 3 is an explanatory diagram illustrating the belt layer of the pneumatic tire illustrated in FIG. 1. The drawings illustrate a multilayer structure of the belt layer 14, and the thin lines in the belt plies 141 to 145 schematically illustrate an arrangement configuration of belt cords.

The belt layer 14 is a multilayer formed by the large-angle belt 141, the pair of cross belts 142, 143, the belt cover 144, and the circumferential reinforcing layer 145, and is disposed being wound over the outer circumference of the carcass layer 13 (see FIG. 2).

The large-angle belt 141 is configured by performing a rolling process of rubber-cover coating on a plurality of belt cords made of steel or an organic fiber material, and has a belt angle (inclination angle of the longitudinal direction of the belt cords with respect to the tire circumferential direction), as an absolute value, ranging from 45 degrees to 70 degrees, and preferably from 54 degrees to 68 degrees. In addition, the large-angle belt 141 is disposed in a layered manner outward of the carcass layer 13 in the tire radial direction.

The pair of cross belts 142, 143 are configured by performing a rolling process of rubber-cover coating on a plurality of belt cords made of steel or an organic fiber material, and each have a belt angle, as an absolute value, ranging from 10 degrees to 55 degrees, and preferably from 14 degrees to 28 degrees. Additionally, the pair of cross belts 142, 143 have belt angles of mutually different signs, and are layered so that the longitudinal directions of the belt cords intersect each other (a crossply structure). In the following description, the cross belt 142 positioned inward in the tire radial direction is referred to as a “radially inner cross belt”, and the cross belt 143 positioned outward in the tire radial direction is referred to as a “radially outer cross belt”. Also, the pair of cross belts 142, 143 are disposed in a layered manner outward of the large-angle belt 141 in the tire radial direction.

Additionally, the belt cover 144 is configured by performing a rolling process of rubber-cover coating on a plurality of belt cords made of steel or an organic fiber material, and has a belt angle, as an absolute value, ranging from 10 degrees to 55 degrees, and preferably from 14 degrees to 28 degrees. Further, the belt cover 144 is disposed in a layered manner outward of the cross belts 142, 143 in the tire radial direction. Note that, in this embodiment, the belt cover 144 has the same belt angle as the radially outer cross belt 143, and is disposed in the outermost layer of the belt layer 14.

The circumferential reinforcing layer 145 is configured by winding around rubber-cover coated steel belt cords in a spiral manner in the tire circumferential direction, and has a belt angle of 5 degrees or less as an absolute value. Additionally, the circumferential reinforcing layer 145 is interposed between the pair of cross belts 142, 143. Also, the circumferential reinforcing layer 145 is disposed inward of left and right edge portions of the pair of cross belts 142, 143 in the tire lateral direction. Specifically, the circumferential reinforcing layer 145 is formed by winding one or a plurality of wires in a spiral manner around the outer circumference of the radially inner cross belt 142. Additionally, the circumferential reinforcing layer 145 is continuous in the tire lateral direction, traversing the tire equatorial plane CL. This circumferential reinforcing layer 145 reinforces rigidity in the tire circumferential direction, thus improving the durability performance of the tire.

### Carcass Profile

As illustrated in FIG. 2, in a cross-sectional view in the tire meridian direction, an intersection point P1 is defined between a carcass profile and a straight line (a reference sign is omitted in the drawing) passing through a point Pe of the edge portion of the shoulder land portion 31 on the outermost circumferential main groove 21 side and parallel with the tire equatorial plane CL.

The point Pe is a measurement point for the groove width of the outermost circumferential main groove 21, and when the outermost circumferential main groove 21 has a zigzag shape, the point Pe is defined as a point on the center line of the amplitude of the zigzag shape. Additionally, when the shoulder land portion 31 has a chamfered portion on the edge portion thereof, the intersection point Pe is defined as an intersection point between an extension line of the road contact surface of the shoulder land portion 31 and an extension line of the groove wall of the outermost circumferential main groove 21.

The carcass profile is defined as a curved line connecting the center points of cross sections of the carcass cords of the carcass layer 13.

Additionally, a point P2 on the carcass profile is defined, which is located in a position corresponding to 95% of a distance Dtw from the tire equatorial plane CL to the tire ground contact edge T in the tire lateral direction. In a typical tread pattern, the distance Dtw is a half-width of the tire ground contact width TW.

Additionally, a distance D2, in the tire lateral direction, from the point P2 to a maximum width position Psec of the carcass profile is defined, and a point P3 on the carcass profile is defined, which is located in a position corresponding to 50% of the distance D2 from the point P2 and outward of the point Psec in the tire radial direction.

Additionally, as a first measurement condition, an unloaded state is defined as a state in which the tire is mounted on a specified rim and inflated to an air pressure corresponding to 5% of a specified internal pressure. When the tire is inflated to the above-described specified internal pressure, the shape of the carcass profile is closest to a profile shape obtained inside a mold for tire vulcanization molding, in other words, to the natural profile shape before inflation.

In the pneumatic tire 1, in the cross-sectional view in the tire meridian direction when the tire is inflated to 5% of the specified internal pressure as described above, a distance Da in the tire radial direction from the intersection point P1 to the point P2 and a distance Db in the tire radial direction from the point P2 to the point P3 have a relationship of Db≤Da. Additionally, the distances Da and Db preferably have a relationship of 1.05≤Da/Db≤1.60, and more preferably have a relationship of 1.20≤Da/Db≤1.50.

Additionally, as a second measurement condition, an unloaded state is defined as a state in which the tire is mounted on a specified rim and inflated to a specified internal pressure. In the description below, the sign “′” is added to dimensions measured when the tire is inflated to the specified internal pressure.

Additionally, in the cross-sectional view in the tire meridian direction when the tire is inflated to 5% of a specified internal pressure, a radius of curvature R1 of the carcass profile in a region extending from the point P1 to the tire equatorial plane CL, and a radius of curvature R2 of an arc passing through the points P1, P2 and P3 have a relationship of R2≤R1. Also, the radii of curvature R1 and R2 preferably have a relationship of 0.70≤R2/R1≤0.95, and more preferably have a relationship of 0.75≤R2/R1≤0.90.

For example, the radius of curvature R1 is measured as a radius of curvature of an arc that passes through an intersection point Pcc (not illustrated) between the tire equatorial plane CL and the carcass profile, a point P4 (not illustrated) on the carcass profile located in a position corresponding to 50% of the distance Dtw, and the point P1.

Additionally, in the cross-sectional view in the tire meridian direction when the tire is inflated to 5% of a specified internal pressure, the radius of curvature R2 of an arc that passes through the points P1, P2, and P3, and a radius of curvature R3 of the carcass profile in a region extending from the point P3 to the point Psec that is the maximum width position of the carcass profile have a relationship of R3≤R2. Also, the radii of curvature R2 and R3 preferably have a relationship of 0.40≤R3/R2≤0.80, and more preferably have a relationship of 0.50≤R3/R2≤0.75.

For example, the radius of curvature R3 is measured as a radius of curvature of an arc that passes through the point P3, the point Psec, and a point P5 (not illustrated) on the carcass profile located in a position corresponding to 50% of the distance D2 from the point P2 and inward of the point Psec in the tire radial direction.

For example, in the configuration in FIG. 2, the carcass profile in a region extending from the tire equatorial plane CL to the carcass maximum width position (the point Psec) is configured by three arcs respectively having the radii of curvature R1, R2, and R3. In addition, the radii of curvature R1, R2, and R3 have a relationship of R3<R2<R1. Then, these arcs are smoothly connected to each other at the point P1 and the point P3, and the carcass profile is formed extending from the tire equatorial plane CL to the carcass maximum width position Psec.

Note that also in the cross sectional view taken along the tire meridian direction when the tire is inflated to a specified internal pressure, the radii of curvature R1, R2, and R3 have the relationship of R3<R2<R1. Accordingly, the shape of the carcass profile is made appropriate.

In addition, in the cross-sectional view in the tire meridian direction when the tire is inflated to 5% of a specified internal pressure, the tire ground contact width TW and a carcass cross-sectional width Wca preferably have a relationship of 0.72≤TW/Wca≤0.93, and more preferably have a relationship of 0.78≤TW/Wca≤0.89 (see FIG. 1). Accordingly, the ratio TW/Wca is made appropriate.

The carcass cross-sectional width Wca is defined as a linear distance between the left and right maximum width positions of the carcass layer 13 when the tire is mounted on a specified rim, is inflated to a specified internal pressure, and is in an unloaded state.

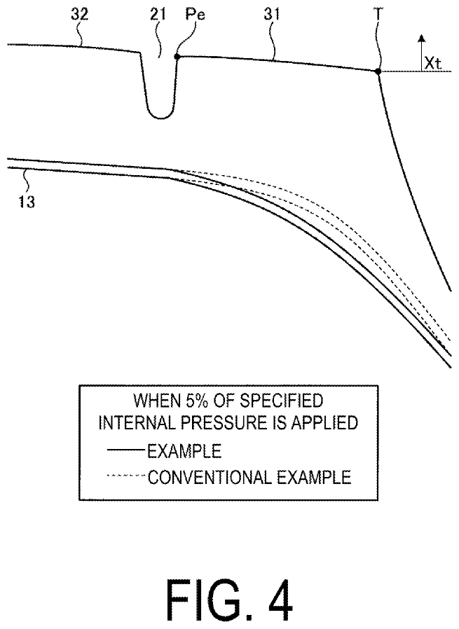

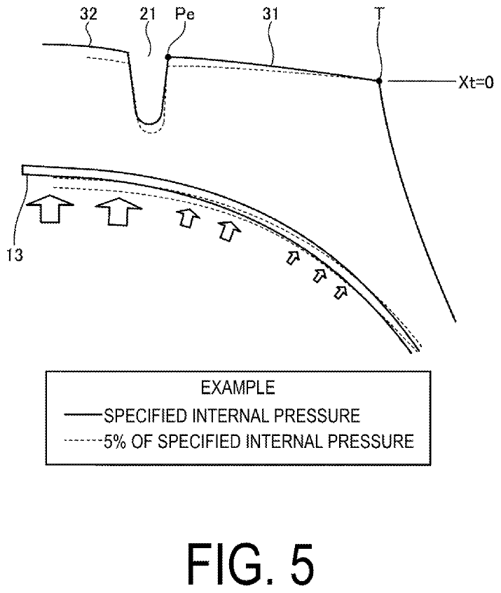

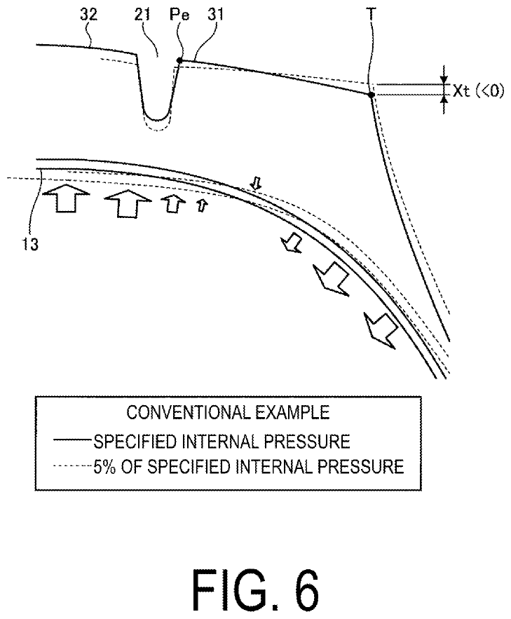

FIGS. 4 to 6 are explanatory diagrams illustrating effects of the pneumatic tire illustrated in FIG. 2. In these drawings, profile lines of the carcass layer 13 and tread surfaces of test tires of Conventional Example and Examples are extracted and schematically illustrated. In addition, FIG. 4 is a comparative explanatory diagram for comparison between Conventional Example and Examples at the time when the tire is inflated to 5% of a specified internal pressure, and FIG. 5 and FIG. 6 are comparative explanatory diagrams of Conventional Example and Examples, respectively comparing states before and after the inflation. Also, arrows in FIG. 5 and FIG. 6 indicate a direction of diameter expansion and an amount of diameter expansion of the profile line of the carcass layer 13 from before to after the inflation.

Additionally, the test tires of Conventional Example and Examples each have the size of 275/70R22.5, are mounted to the rim of 22.5×8.25, and are in an unloaded state in which the tires are inflated to the internal pressure specified by JATMA or 5% of the specified internal pressure. At this time, the profile lines of the carcass layer 13 and the tread surface of each of the test tires are calculated using the Finite Element Method (FEM) inflation calculation.

The test tire of Example has the structure illustrated in FIG. 1 and FIG. 2, and in a cross-sectional view in the tire meridian direction when the tire is inflated to 5% of the specified internal pressure, the distance Da in the tire radial direction from the intersection point P1 to the point P2 and the distance Db in the tire radial direction from the point P2 to the point P3 have a relationship of Da/Db=1.50, and the radii of curvature R1, R2, and R3 satisfy the conditions of R2/R1=0.80, R3/R2=0.60, and R2=150 mm.

The test tire of Conventional Example has the same structure as the test tire of Example, and in the cross-sectional view in the tire meridian direction when the tire is inflated to 5% of the specified internal pressure, the distance Da in the tire radial direction from the intersection point P1 to the point P2 and the distance Db in the tire radial direction from the point P2 to the point P3 have a relationship of Da/Db=0.75, and the radii of curvature R1, R2, and R3 satisfy the conditions of R2/R1=0.50, R3/R2=0.60, and R2=120 mm.

As illustrated in FIG. 4, the profile lines of the tread surfaces of Conventional Example and Example are matched up with each other before the inflation (when the tire is inflated to 5% of a specified internal pressure).

Additionally, the profile lines of the carcass layers 13 of Conventional Example and Example are matched up with each other from the tire equatorial plane CL to a region at or near the groove bottom of the outermost circumferential main groove 21 (at or near the point P1 in FIG. 2). However, in a region outward of the outermost circumferential main groove 21 in the tire lateral direction, namely, in a region below the shoulder land portion 31, since the ratio Da/Db (see FIG. 2) of the carcass profile of Example is large, the outer diameter of the carcass layer 13 of Example decreases more steeply than that of Conventional Example.

As illustrated in FIG. 5, in the test tire of Example, overall, the diameter of the profile line of the carcass layer 13 is expanded from before to after the inflation (when inflation air pressure is increased from 5% to 100% of the specified internal pressure, and the same applies below). In particular, the profile line of the carcass layer 13 in the ground contact region of the shoulder land portion 31 is deformed toward the expanded diameter side, from before to after the inflation. As a result, the profile line of the road contact surface of the shoulder land portion 31 is deformed toward the expanded diameter side from before to after the inflation, over the entire region of the shoulder land portion 31. Specifically, an amount of diameter expansion Xt of the tire ground contact edge T from before to after the inflation is Xt=0 mm, and the tire ground contact edge T is not displaced from before to after the inflation. In addition, the amounts of diameter expansion (dimension symbols are omitted in the drawings) of the edge portions of the shoulder land portion 31 and the second land portion 32 on the outermost circumferential main groove 21 side from before to after the inflation are both positive values. Thus, the amount of diameter expansion of the road contact surface of the shoulder land portion 31 from before to after the inflation gradually decreases from the point Pe of the edge portion of the shoulder land portion 31 on the outermost circumferential main groove 21 side, toward the outside in the tire lateral direction, and becomes zero (Xt=0 mm) at the tire ground contact edge T. Thus, the road contact surface of the shoulder land portion 31 is deformed toward the expanded diameter side over the entire region from before to after the inflation.

In contrast, as illustrated in FIG. 6, in the test tire of Conventional Example, the diameter of the profile line of the carcass layer 13 is expanded from before to after the inflation over the entire region on the tire equatorial plane CL side, with a region at or near a central portion of the shoulder land portion 31 being a boundary, and then, the diameter is contracted on the tire ground contact edge T side. As a result, the amount of diameter expansion Xt of the tire ground contact edge T from before to after the inflation is Xt<0 mm, and the tire ground contact edge T is displaced toward the contracted diameter side. Meanwhile, the amounts of diameter expansion (dimension symbols are omitted in the drawings) of the edge portions of the shoulder land portion 31 and the second land portion 32 on the outermost circumferential main groove 21 side from before to after the inflation are both positive values, similarly to the case illustrated in FIG. 5. Thus, it is found that, compared with Example illustrated in FIG. 5, the road contact surface of the shoulder land portion 31 is significantly deformed from before to after the inflation.

According to the calculation results of the FEM inflation calculation, changes in the shape of the carcass profile from before to after the inflation in Example illustrated in FIG. 5 are smaller than those in Conventional Example illustrated in FIG. 6. Accordingly, the maximum distortion of the groove bottom of the outermost circumferential main groove 21 after the inflation is reduced, and the generation of a groove crack in the outermost circumferential main groove 21 is suppressed.

### Added Items

In this pneumatic tire 1, in the cross-sectional view in the tire meridian direction when the tire is inflated to a specified internal pressure, a ground contact width TW' and a carcass cross-sectional width Wca′ preferably have a relationship of 0.82≤TW′/Wca′≤0.92 (see FIG. 1). Accordingly, the ratio TW′/Wca′ is made appropriate, and the contact pressure distribution in the tire lateral direction is made uniform. In particular, in the configuration in which the belt layer 14 includes the circumferential reinforcing layer 145, radial growth in a tread portion center region is suppressed by the circumferential reinforcing layer 145. At this time, since the ratio TW′/Wca′ is within the above-described range, a difference in the radial growth between the tread portion center region and the shoulder regions is alleviated, and the contact pressure distribution in the tire lateral direction is made uniform. Accordingly, the distortion amount of the groove bottom of the outermost circumferential main groove 21 is reduced.

In addition, in the cross-sectional view in the tire meridian direction when the tire is inflated to a specified internal pressure, a diameter Ya′ of the carcass layer 13 at the maximum height position and a diameter Yc′ of the carcass layer 13 at the maximum width position preferably have a relationship of 0.65≤Yc′/Ya′≤0.90 (see FIG. 1). Accordingly, the cross-sectional shape of the carcass layer 13 is made appropriate, and, accordingly, the contact pressure distribution of the tire is made uniform.

In addition, in the cross-sectional view in the tire meridian direction, when the tire is inflated to a specified internal pressure, the diameter Ya′ of the carcass layer 13 at the maximum height position and a diameter Yd′ of the carcass layer 13 at the point P1 (the point corresponding to a region at or near the groove bottom of the outermost circumferential main groove 21) of the carcass profile preferably have a relationship of 0.95≤Yd′/Ya′≤1.02. Accordingly, the shape of the carcass layer 13 is made appropriate, and a deformation amount of the carcass layer 13 below the outermost circumferential main groove 21 is decreased when the tire comes into contact with the ground.

Diameters Ya, Yc, and Yd of the carcass layer 13 are distances from the tire rotation axis to each measurement point of the carcass profile, measured when the tire is mounted on a specified rim, is inflated to a specified internal pressure, and is in an unloaded state.

In addition, in the cross-sectional view in the tire meridian direction when the tire is inflated to a specified internal pressure, an outer diameter Hcc′ of the tread profile in the tire equatorial plane CL, and an outer diameter Hsh′ of the tread profile at the tire ground contact edge T satisfy 0.006≤(Hcc′−Hsh′)/Hcc′≤0.015 (refer to FIG. 1). Accordingly, a shoulder drop amount ΔH′ (=Hcc′−Hsh′) in the tread portion shoulder region is made appropriate, and thereby, the contact pressure distribution of the tire is made uniform.

Outer diameters Hcc and Hsh of the tread profile are distances from the tire rotation axis to each measurement point, measured when the tire is mounted on a specified rim, is inflated to a predetermined internal pressure, and is in an unloaded state.

In addition, in the cross-sectional view in the tire meridian direction when the tire is inflated to a specified internal pressure, a width Wb2′ of the wider cross belt (see FIG. 2, the radially inner cross belt 142 in the drawing) among the pair of cross belts 142, 143, and the cross-sectional width Wca′ of the carcass layer 13 (see FIG. 1) have a relationship of 0.73≤Wb2′/Wca′≤0.89. Accordingly, the width Wb2′ of the wider cross belt is made appropriate, and the rigidity in the tire circumferential direction is made appropriate.

In addition, in the cross-sectional view in the tire meridian direction when the tire is inflated to a specified internal pressure, a width Ws′ of the circumferential reinforcing layer 145 and the width Wca′ of the carcass layer 13 preferably have a relationship of 0.60≤Ws′/Wca′≤0.70 (see FIG. 1). Accordingly, the width Ws′ of the circumferential reinforcing layer 145 is made appropriate, and the rigidity in the tire circumferential direction is made appropriate.

In addition, as illustrated in FIG. 3, a width Wb2 of the wider cross belt among the pair of cross belts 142, 143 (see FIG. 2, the radially inner cross belt 142 in the drawing), and a width Ws of the circumferential reinforcing layer 145 preferably have a relationship of Ws<Wb2. In addition, left and right end portions of the circumferential reinforcing layer 145 are disposed inward of left and right end portions of the wider cross belt 142 in the tire lateral direction. Accordingly, the width Ws of the circumferential reinforcing layer 145 is made appropriate, and the rigidity in the tire circumferential direction is made appropriate.

In addition, when the tire is inflated to 5% of the specified internal pressure as described above, the shape of the carcass profile is preferably applied to the configuration (see FIG. 1 and FIG. 2) in which the outer edge portion of the circumferential reinforcing layer 145 in the tire lateral direction is disposed inward of the groove bottom of the outermost circumferential main groove 21 in the tire lateral direction. In this configuration, since a rigidity difference in the tire circumferential direction is generated between the inside and outside of the disposed region of the circumferential reinforcing layer 145, the distortion amount of the groove bottom of the outermost circumferential main groove 21 tends to become large. Thus, by adopting this configuration, effects of reducing the distortion amount of the groove bottom of the outermost circumferential main groove 21 by making the shape of the carcass profile appropriate are obtained efficiently.

The widths Wb2, Wb3, and Ws of the belt plies 142, 143, and 145 are distances in the tire lateral direction between left and right end portions of each of the belt plies 142, 143, and 145, measured when the tire is mounted on a specified rim, is inflated to a predetermined internal pressure, and is in an unloaded state.

### Effects

As described above, the pneumatic tire 1 includes the carcass layer 13 and the belt layer 14 disposed outward of the carcass layer 13 in the tire radial direction, and at the same time, includes, in the tread surface, the plurality of circumferential main grooves 21 to 24 and the plurality of land portions 31 to 34 defined by the circumferential main grooves 21 to 24 (see FIG. 1). In addition, when the tire is mounted on a specified rim, is inflated to an air pressure corresponding to 5% of a specified internal pressure, and is in an unloaded state, with the points P1, P2, and P3 being defined on the carcass profile illustrated in FIG. 2, the distance Da from the intersection point P1 to the point P2 in the tire radial direction and the distance Db from the point P2 to the point P3 in the tire radial direction have a relationship of Db≤Da.

In this configuration, the shape of the carcass profile in the tread portion shoulder region is made appropriate, and the maximum distortion of the groove bottom of the outermost circumferential main groove 21 after the inflation is reduced (see FIG. 4 to FIG. 6). Accordingly, the generation of a groove crack in the outermost circumferential main groove 21 is suppressed, and there is an advantage that the groove cracking resistance performance of the tire is improved.

In addition, in the pneumatic tire 1, in the cross-sectional view in the tire meridian direction when the tire is mounted on a specified rim, is inflated to an air pressure corresponding to 5% of a specified internal pressure, and is in an unloaded state, the radius of curvature R1 of the carcass profile in the region extending from the point P1 to the tire equatorial plane CL, and the radius of curvature R2 of the arc passing through the points P1, P2, and P3 have a relationship of R2≤R1 (see FIG. 2). Accordingly, the shape of the carcass profile is made appropriate, and there is an advantage that the maximum distortion of the groove bottom of the outermost circumferential main groove 21 after the inflation is reduced.

In addition, in the pneumatic tire 1, in the cross-sectional view in the tire meridian direction when the tire is mounted on a specified rim, is inflated to an air pressure corresponding to 5% of a specified internal pressure, and is in an unloaded state, the radius of curvature R2 of the arc passing through the points P1, P2, and P3, and the radius of curvature R3 of the carcass profile in the region extending from the point P3 to the maximum width position of the carcass profile have a relationship of R3<R2 (see FIG. 2). Accordingly, the shape of the carcass profile is made appropriate, and there is an advantage that the maximum distortion of the groove bottom of the outermost circumferential main groove 21 after the inflation is reduced.

In addition, in this pneumatic tire 1, in the cross-sectional view in the tire meridian direction when the tire is mounted on a specified rim, is inflated to an air pressure corresponding to 5% of a specified internal pressure, and is in an unloaded state, a tire ground contact width TW and the carcass cross-sectional width Wca have a relationship of 0.72≤TW/Wca≤0.93 (see FIG. 1). Accordingly, the ratio TW/Wca is made appropriate, and there is an advantage that the shape of the carcass profile before and after the inflation is made appropriate. In other words, given that the relationship 0.72≤TW/Wca is satisfied, the relationship of the distances Da and Db (Db≤Da) can be appropriately ensured.

In addition, in the pneumatic tire 1, in the cross-sectional view in the tire meridian direction, when the tire is mounted on a specified rim in a unloaded state, and when the inflation air pressure is increased from 5% to 100% of the specified internal pressure, the diameter expansion amount Xt of the tire ground contact edge T satisfies the condition of 0 mm≤Xt (see FIG. 5). In this configuration, the profile line of the road contact surface of the shoulder land portion 31 (in other words, the region extending from the edge portion on the outermost circumferential main groove 21 side to the tire ground contact edge T) is deformed toward the expanded diameter side from before to after the inflation, over the entire region of the shoulder land portion 31. Accordingly, the maximum distortion of the groove bottom of the outermost circumferential main groove 21 after the inflation is reduced, and there is an advantage that the generation of a groove crack in the outermost circumferential main groove 21 is suppressed.

In addition, in this pneumatic tire 1, in the cross-sectional view in the tire meridian direction when the tire is mounted on a specified rim, is inflated to a specified internal pressure, and is in an unloaded state, the tire ground contact width TW′ and the carcass cross-sectional width Wca′ have a relationship of 0.82≤TW′/Wca′≤0.92 (see FIG. 1). In this configuration, the ratio TW′/Wca′ is made appropriate, and the contact pressure distribution in the tire lateral direction is made uniform. Accordingly, the distortion amount of the groove bottom of the outermost circumferential main groove 21 is reduced, and there is an advantage that the generation of a groove crack in the outermost circumferential main groove 21 is suppressed.

In addition, in this pneumatic tire 1 in the in the cross-section view in the tire meridian direction when the tire is mounted on a specified rim, is inflated to a specified internal pressure, and is in an unloaded state, the diameter Ya′ of the carcass layer 13 at the maximum height position and the diameter Yc′ of the carcass layer 13 at the maximum width position have a relationship of 0.65≤Yc′/Ya′≤0.90 (see FIG. 1). Accordingly, the cross-sectional shape of the carcass layer 13 is made appropriate, and there is an advantage that the contact pressure distribution of the tire is made uniform.

In addition, in this pneumatic tire 1, in the cross-sectional view in the tire meridian direction when the tire is mounted on a specified rim, is inflated to a specified internal pressure, and is in an unloaded state, the diameter Ya′ of the carcass layer 13 at the maximum height position and the diameter Yd′ of the carcass layer 13 at the point P1 have a relationship of 0.95≤Yd′/Ya′≤1.02 (see FIG. 1). Accordingly, the cross-sectional shape of the carcass layer 13 is made appropriate, and there is an advantage that the contact pressure distribution of the tire is made uniform.

In addition, in this pneumatic tire 1, in the cross-sectional view in the tire meridian direction when the tire is mounted on a specified rim, is inflated to a specified internal pressure, and is in an unloaded state, the outer diameter Hcc′ of the tread profile on the tire equatorial plane CL and the outer diameter Hsh′ of the tread profile at the tire ground contact edge T have a relationship of 0.006≤(Hcc′−Hsh′)/Hcc′≤0.015 (see FIG. 1). Accordingly, the shoulder drop amount ΔH′ (=Hcc′−Hsh′) in the tread portion shoulder region is made appropriate, and there is an advantage that the contact pressure distribution of the tire is made uniform.

In addition, in this pneumatic tire 1, in the cross-sectional view in the tire meridian direction when the tire is mounted on a specified rim, is inflated to a specified internal pressure, and is in an unloaded state, the width Wb2′ of the wider cross belt among the radially inner cross belt 142 and the radially outer cross belt 143 (in FIG. 1, the radially inner cross belt 142), and the cross-sectional width Wca′ of the carcass layer 13 have a relationship of 0.73≤Wb2′/Wca′≤0.89. Accordingly, there is an advantage that the ratio Wb2′/Wca′ is made appropriate. In other words, given that the relationship 0.73≤Wb2′/Wca′ is satisfied, the width Wb2 of the wider cross belt is ensured, and the rigidity in the tire circumferential direction is ensured. In addition, given that the relationship Wb2′/Wca′≤0.89 is satisfied, the rigidity in the tire circumferential direction is prevented from being excessively high.

In addition, in this pneumatic tire 1, in the cross-sectional view in the tire meridian direction when the tire is mounted on a specified rim, is inflated to a specified internal pressure, and is in an unloaded state, the width Ws′ of the circumferential reinforcing layer 145 and the width Wca′ of the carcass layer 13 have a relationship of 0.60≤Ws′/Wca′≤0.70 (see FIG. 1). In this configuration, given that the ratio Ws′/Wca′ is within the above-described range, the difference in radial growth between the tread portion center region and the shoulder regions is alleviated, and the contact pressure distribution in the tire lateral direction is made uniform. Accordingly, there is an advantage that the distortion amount of the groove bottom of the outermost circumferential main groove 21 is reduced.

In addition, in this pneumatic tire 1, the width Wb2 of the wider cross belt among the pair of cross belts 142 and 143 and the width Ws of the circumferential reinforcing layer 145 have a relationship of Ws<Wb2 (see FIG. 3). Accordingly, there is an advantage that the width Ws of the circumferential reinforcing layer 145 is made appropriate.

In addition, in this pneumatic tire 1, the outer edge portion of the circumferential reinforcing layer 145 in the tire lateral direction is disposed inward of the groove bottom of the outermost circumferential main groove 21 in the tire lateral direction (see FIG. 1). By adopting this configuration, there is an advantage that the reduction effects of reducing the distortion amount of the groove bottom of the outermost circumferential main groove 21 by making the shape of the carcass profile appropriate are obtained efficiently.

### EXAMPLES

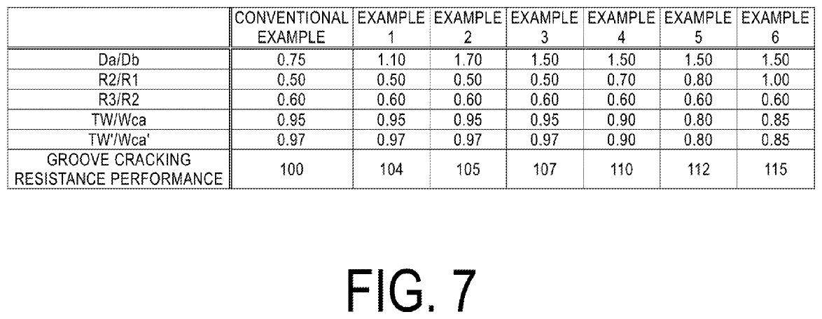

FIG. 7 is a table showing the results of performance tests of pneumatic tires according to the embodiment of the technology. In the same drawing, the sign “′” is added to dimensions measured when the tire is inflated to a specified internal pressure.

In the performance tests, a plurality of types of test tires were evaluated for the groove cracking resistance performance. In addition, the test tires having a tire size of 275/70R22.5 were mounted on rims having a rim size of 22.5×8.25, and an air pressure of 630 kPa (80% of the internal pressure specified by JATMA) and 120% of the load specified by JATMA were applied to the test tires.

Durability performance evaluation was carried out through low pressure durability tests using an indoor drum testing machine, while blowing ozone onto the test tires. Then, after the test tires were driven for 20,000 km at a running speed of 50 km/h, the number and the lengths of the groove cracks generated in the outermost circumferential main groove 21 were measured. The measurement results are expressed as index values and evaluated while using Conventional Example as a reference (100). In this evaluation, larger values are preferable, and a value of 105 or greater indicates superiority.

The test tires of Examples 1 to 6 have the structure illustrated in FIG. 1 to FIG. 3. In addition, when the tire is inflated to a specified internal pressure, the tire ground contact width TW′ is TW′=240 mm, the diameters Ya′, Yc′, and Yd′ at each position of the carcass layer 13 are Ya′=900 mm, Yc′=785 mm, and Yd′=898 mm, and the outer diameters Hcc′ and Hsh′ at each position of the tread profile are Hcc′=970 mm and Hsh′=960 mm. In addition, when the tire is inflated to 5% of the specified internal pressure, the tire ground contact width TW is TW=240 mm.

The test tire of Conventional Example has the distances Da and Db that satisfy the relationship of Da<Db in the test tire of Example 1.

As can be seen from the test results, in the test tires of Examples 1 to 6, the groove cracking resistance performance of the tires is improved.

1. A pneumatic tire comprising a carcass layer and a belt layer disposed outward of the carcass layer in a tire radial direction, and further comprising, in a tread surface thereof, a plurality of circumferential main grooves and a plurality of land portions defined by the plurality of circumferential main grooves, wherein
circumferential main grooves disposed outermost in a tire lateral direction are defined as outermost circumferential main grooves, and the land portions defied by the outermost circumferential main grooves and disposed outward in the tire lateral direction are defined as shoulder land portions,
in a cross-sectional view in a tire meridian direction, an intersection point P1 is defined between a carcass profile and a straight line that passes through a point Pe of an edge portion of the shoulder land portion on an outermost circumferential main groove side and that is parallel with a tire equatorial plane, a point P2 is defined on the carcass profile in a position corresponding to 95% of a distance Dtw from the tire equatorial plane to a tire ground contact edge in the tire lateral direction, a distance D2 is defined from the point P2 to a maximum width position of the carcass profile in the tire lateral direction, and a point P3 is defined on the carcass profile in a position corresponding to 50% of the distance D2 from the point P2, and
when the tire is mounted on a specified rim, is inflated to an air pressure corresponding to 5% of a specified internal pressure, and is in an unloaded state, a distance Da from the intersection point P1 to the point P2 in the tire radial direction and a distance Db from the point P2 to the point P3 in the tire radial direction have a relationship of Db≤Da.

2. The pneumatic tire according to claim 1, wherein
in the cross-sectional view in the tire meridian direction when the tire is mounted on the specified rim, is inflated to the air pressure corresponding to 5% of the specified internal pressure, and is in the unloaded state,
a radius of curvature R1 of the carcass profile in a region extending from the point P1 to the tire equatorial plane, and a radius of curvature R2 of an arc passing through the points P1, P2, and P3 have a relationship of R2≤R1.

3. The pneumatic tire according to claim 1, wherein
in the cross-sectional view in the tire meridian direction when the tire is mounted on the specified rim, is inflated to the air pressure corresponding to 5% of the specified internal pressure, and is in the unloaded state,
a radius of curvature R2 of an arc passing through the points P1, P2, and P3, and a radius of curvature R3 of the carcass profile in a region extending from the point P3 to the maximum width position of the carcass profile have a relationship of R3<R2.

4. The pneumatic tire according to claim 1, wherein
in the cross-sectional view in the tire meridian direction when the tire is mounted on the specified rim, is inflated to the air pressure corresponding to 5% of the specified internal pressure, and is in the unloaded state,
a tire ground contact width TW and a carcass cross-sectional width Wca have a relationship of 0.72≤TW/Wca≤0.93.

5. The pneumatic tire according to claim 1, wherein
in the cross-sectional view in the tire meridian direction when the tire is mounted on the specified rim in the unloaded state,
when an inflation air pressure is increased from 5% to 100% of the specified internal pressure, a diameter expansion amount Xt of the tire ground contact edge satisfies a condition of 0 mm≤Xt.

6. The pneumatic tire according to claim 1, wherein
in the cross-sectional view in the tire meridian direction when the tire is mounted on the specified rim, is inflated to the specified internal pressure, and is in the unloaded state,
a tire ground contact width TW′ and a carcass cross-sectional width Wca′ have a relationship of 0.82≤TW′/Wca′≤0.92.

7. The pneumatic tire according to claim 1, wherein
in the cross-sectional view in the tire meridian direction when the tire is mounted on the specified rim, is inflated to the specified internal pressure, and is in the unloaded state,
a diameter Ya′ of the carcass layer at a maximum height position and a diameter Yc′ of the carcass layer at a maximum width position have a relationship of 0.80≤Yc′/Ya′≤0.90.

8. The pneumatic tire according to claim 1, wherein
in the cross-sectional view in the tire meridian direction when the tire is mounted on the specified rim, is inflated to the specified internal pressure, and is in the unloaded state,
a diameter Ya′ of the carcass layer at a maximum height position and a diameter Yd′ of the carcass layer at the point P1 have a relationship of 0.95≤Yd′/Ya′≤1.02.

9. The pneumatic tire according to claim 1, wherein
in the cross-sectional view in the tire meridian direction when the tire is mounted on the specified rim, is inflated to the specified internal pressure, and is in the unloaded state,
a relationship between an outer diameter Hcc′ of a tread profile on the tire equatorial plane and an outer diameter Hsh′ of the tread profile at the tire ground contact edge have a relationship of 0.006≤(Hcc′−Hsh′)/Hcc′≤0.015.

10. The pneumatic tire according to claim 1, wherein
the belt layer comprises a pair of cross belts having belt angles of mutually different signs, and a circumferential reinforcing layer having, as an absolute value, a belt angle of 5 degrees or less, and
in the cross-sectional view in the tire meridian direction when the tire is mounted on the specified rim, is inflated to the specified internal pressure, and is in the unloaded state,
a width Wb2′ of a wider cross belt among the pair of cross belts and a cross-sectional width Wca′ of the carcass layer have a relationship of 0.73≤Wb2′/Wca′≤0.89.

11. The pneumatic tire according to claim 1, wherein
the belt layer comprises a pair of cross belts having belt angles of mutually different signs and a circumferential reinforcing layer having, as an absolute value, a belt angle of 5 degrees or less, and
in the cross-sectional view in the tire meridian direction when the tire is mounted on the specified rim, is inflated to the specified internal pressure, and is in the unloaded state,
a width Ws′ of the circumferential reinforcing layer and a width Wca′ of the carcass layer have a relationship of 0.60≤Ws′/Wca′≤0.70.

12. The pneumatic tire according to claim 1, wherein
the belt layer comprises a pair of cross belts having belt angles of mutually different signs and a circumferential reinforcing layer having, as an absolute value, a belt angle of 5 degrees or less, and
a width Wb2 of a wider cross belt among the pair of cross belts and a width Ws of the circumferential reinforcing layer have a relationship of Ws<Wb2.

13. The pneumatic tire according to claim 1, wherein
the belt layer comprises a pair of cross belts having belt angles of mutually different signs and a circumferential reinforcing layer having, as an absolute value, a belt angle of 5 degrees or less, and
an outer edge portion of the circumferential reinforcing layer in the tire lateral direction is disposed inward of a groove bottom of the outermost circumferential main groove in the tire lateral direction.

14. The pneumatic tire according to claim 2, wherein
in the cross-sectional view in the tire meridian direction when the tire is mounted on the specified rim, is inflated to the air pressure corresponding to 5% of the specified internal pressure, and is in the unloaded state,
the radius of curvature R2 of the arc passing through the points P1, P2, and P3, and a radius of curvature R3 of the carcass profile in a region extending from the point P3 to the maximum width position of the carcass profile have a relationship of R3<R2.

15. The pneumatic tire according to claim 14, wherein
in the cross-sectional view in the tire meridian direction when the tire is mounted on the specified rim, is inflated to the air pressure corresponding to 5% of the specified internal pressure, and is in the unloaded state,
a tire ground contact width TW and a carcass cross-sectional width Wca have a relationship of 0.72≤TW/Wca≤0.93.

16. The pneumatic tire according to claim 15, wherein
in the cross-sectional view in the tire meridian direction when the tire is mounted on the specified rim in the unloaded state,
when an inflation air pressure is increased from 5% to 100% of the specified internal pressure, a diameter expansion amount Xt of the tire ground contact edge satisfies a condition of 0 mm≤Xt.

17. The pneumatic tire according to claim 16, wherein
in the cross-sectional view in the tire meridian direction when the tire is mounted on the specified rim, is inflated to the specified internal pressure, and is in the unloaded state,
a tire ground contact width TW′ and a carcass cross-sectional width Wca′ have a relationship of 0.82≤TW′/Wca′≤0.92.

18. The pneumatic tire according to claim 17, wherein
in the cross-sectional view in the tire meridian direction when the tire is mounted on the specified rim, is inflated to the specified internal pressure, and is in the unloaded state,
a diameter Ya′ of the carcass layer at a maximum height position and a diameter Yc′ of the carcass layer at a maximum width position have a relationship of 0.80≤Yc′/Ya′≤0.90.

19. The pneumatic tire according to claim 18, wherein
in the cross-sectional view in the tire meridian direction when the tire is mounted on the specified rim, is inflated to the specified internal pressure, and is in the unloaded state,
the diameter Ya′ of the carcass layer at the maximum height position and a diameter Yd′ of the carcass layer at the point P1 have a relationship of 0.95≤Ya′/Ya′≤1.02.

20. The pneumatic tire according to claim 19, wherein
in the cross-sectional view in the tire meridian direction when the tire is mounted on the specified rim, is inflated to the specified internal pressure, and is in the unloaded state,
a relationship between an outer diameter Hcc′ of a tread profile on the tire equatorial plane and an outer diameter Hsh′ of the tread profile at the tire ground contact edge have a relationship of 0.006≤(Hcc′−Hsh′)/Hcc′≤0.015.
